(19) United States
(12) Patent Application Publication
(10) Pub. No.: US 2026/0229409 A1
(43) Pub. Date: Aug. 6, 2026

(54) MULTILAYER CERAMIC CAPACITOR

(71) Applicant: Murata Manufacturing Co., Ltd., Nagaokakyo-shi (JP)

(72) Inventor: Kazunori USUI, Nagaokakyo-shi (JP)

(21) Appl. No.: 19/634,370

(22) Filed: Mar. 31, 2026

Related U.S. Application Data
(63) Continuation of application No. PCT/JP2025/000806, filed on Jan. 14, 2025.

(30) Foreign Application Priority Data
Jan. 29, 2024 (JP) 2024-011162

(51) Int. Cl. H01G 4/008; H01G 4/12; H01G 4/30

(52) U.S. Cl. CPC H01G 4/008; H01G 4/1209; H01G 4/30

(57) ABSTRACT

A multilayer ceramic capacitor includes a multilayer body that includes an inner layer portion including a plurality of inner dielectric layers and a plurality of inner electrode layers laminated in a first direction, and a pair of outer layer portions holding the inner layer portion therebetween in the first direction, and a pair of outer electrodes located at two end portions of the multilayer body in a second direction and connected to the inner electrode layers. The plurality of inner electrode layers include Ni as a main component, and an Mn—Ni oxide area is included in at least a portion of any of the plurality of inner electrode layers.

### CROSS REFERENCE TO RELATED APPLICATIONS

This application claims the benefit of priority to Japanese Patent Application No. 2024-011162 filed on Jan. 29, 2024 and is a Continuation Application of PCT Application No. PCT/JP2025/000806 filed on Jan. 14, 2025. The entire contents of each application are hereby incorporated herein by reference.

### BACKGROUND OF THE INVENTION

### 1. Field of the Invention

The present invention relates to multilayer ceramic capacitors.

### 2. Description of the Related Art

Known multilayer ceramic capacitors mounted on electronic devices generally include an inner layer portion in which inner electrodes and dielectric layers are alternately laminated, and an outer layer portion formed from a dielectric layer. The inner layer portion contributes to formation of capacitance, and the outer layer portion contributes to reliability.

With size reduction and thickness reduction of electronic devices, size reduction and thickness reduction of multilayer ceramic capacitors have been demanded. Thickness reduction of dielectric layers forming inner layer portions or outer layer portions to achieve size reduction and thickness reduction of multilayer ceramic capacitors may lower reliability of multilayer ceramic capacitors.

### SUMMARY OF THE INVENTION

Disposing an insulating layer to cover the surface of a capacitor body as described in, for example, Japanese Unexamined Patent Application Publication No. 2023-113923 to retain reliability of a multilayer ceramic capacitor involves a process of installing the insulating layer, and increases the entire thickness by the thickness of the insulating layer. This increase in thickness is more likely to block the size reduction and the thickness reduction of a multilayer ceramic capacitor.

Example embodiments of the present invention provide multilayer ceramic capacitors each capable of improving waterproofness without increasing a thickness of an outer layer portion.

The present inventors have discovered that reliability of a multilayer ceramic capacitor improves when multiple inner electrode layers include Ni as the main component, and at least a portion of any of the multiple inner electrode layers includes a nickel manganese (Mn—Ni) oxide area, and thus have conceived of and developed example embodiments of the present invention.

More specifically, an example embodiment of the present invention provides a multilayer ceramic capacitor that includes a multilayer body that includes an inner layer portion including a plurality of inner dielectric layers and a plurality of inner electrode layers laminated in a first direction, and a pair of outer layer portions including outer dielectric layers holding the inner layer portion therebetween in the first direction, the multilayer body including a first surface and a second surface opposite each other in the first direction, a third surface and a fourth surface opposite each other in a second direction perpendicular to the first direction, and a fifth surface and a sixth surface opposite each other in a third direction perpendicular to the first direction and the second direction, and a pair of outer electrodes located at two end portions of the multilayer body in the second direction or the third direction, and connected to the inner electrode layers, wherein the plurality of inner electrode layers include Ni as a main component, and a nickel manganese oxide area is included in at least a portion of any of the plurality of inner electrode layers.

Multilayer ceramic capacitors according to example embodiments of the present invention are capable of improving waterproofness without increasing the thickness of the outer layer portions.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to a first example embodiment of the present invention.

FIG. 2 is a cross-sectional view of the multilayer ceramic capacitor taken along line II-II illustrated in FIG. 1 (D12 cross section).

FIG. 3 is a cross-sectional view of the multilayer ceramic capacitor taken along line III-III illustrated in FIG. 1 (D13 cross section).

FIG. 4 is a schematic diagram of a structure of inner layer portions in the multilayer ceramic capacitor illustrated in FIG. 1.

FIG. 5 is a perspective view of a multilayer ceramic capacitor according to a second example embodiment of the present invention.

FIG. 6 is a schematic diagram of a structure of inner layer portions in the multilayer ceramic capacitor illustrated in FIG. 5.

FIG. 7 is a partially enlarged view of a multilayer ceramic capacitor in the D12 cross section that includes nickel manganese (Mn—Ni) oxide areas A.

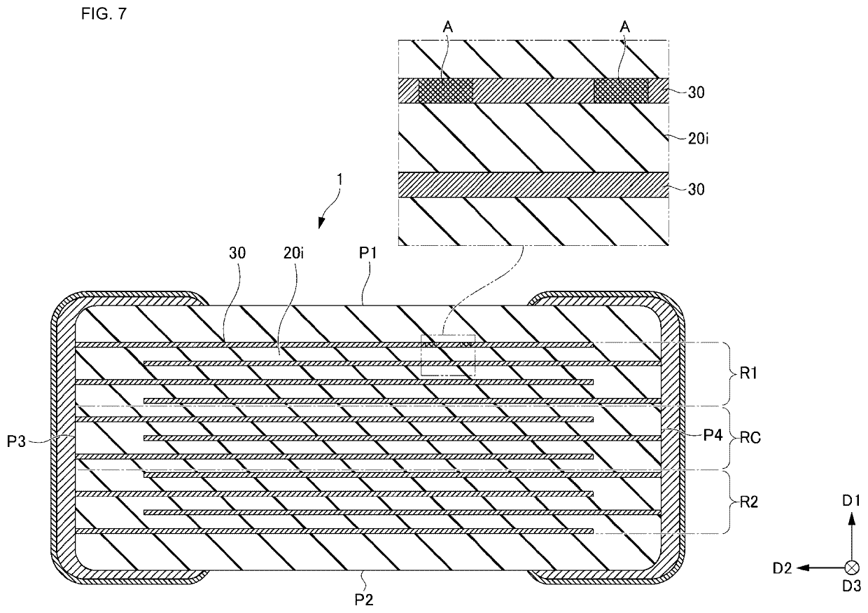

### DETAILED DESCRIPTION OF THE EXAMPLE EMBODIMENTS

Hereafter, multilayer ceramic capacitors according to example embodiments of the present invention are described, but the present invention is not limited to these examples. To describe the details of example embodiments of the present invention, the drawings may be schematically and simply drawn, and drawn components or the dimensional ratios between the components may be different from the components or the ratios described herein. The components described herein may be omitted in the drawings or fewer components may be drawn.

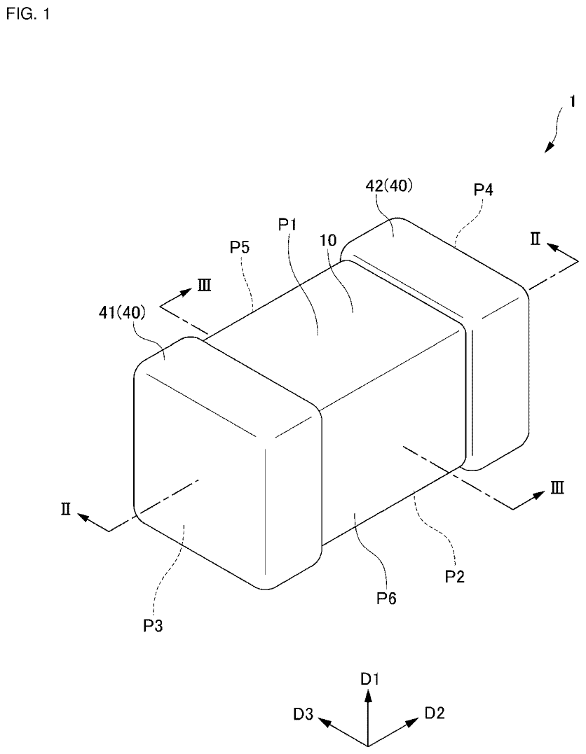

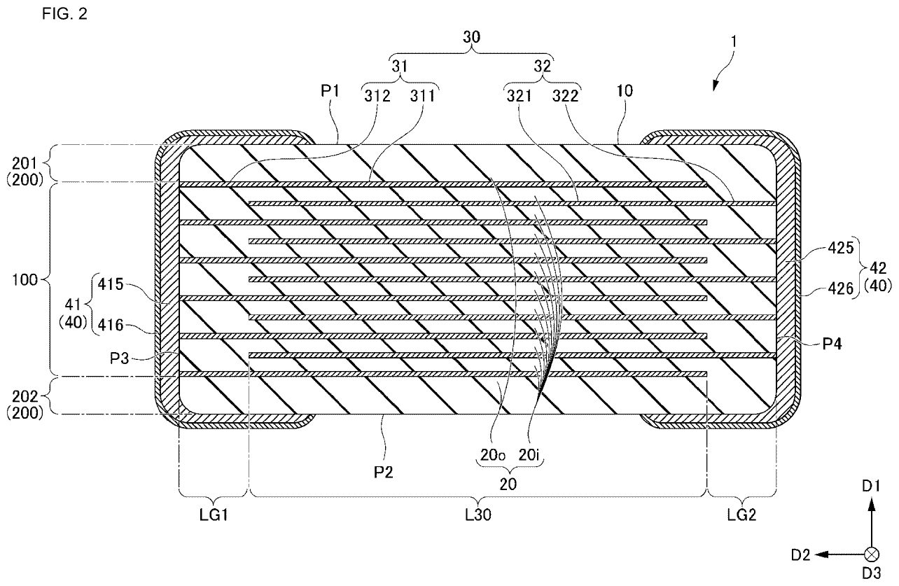

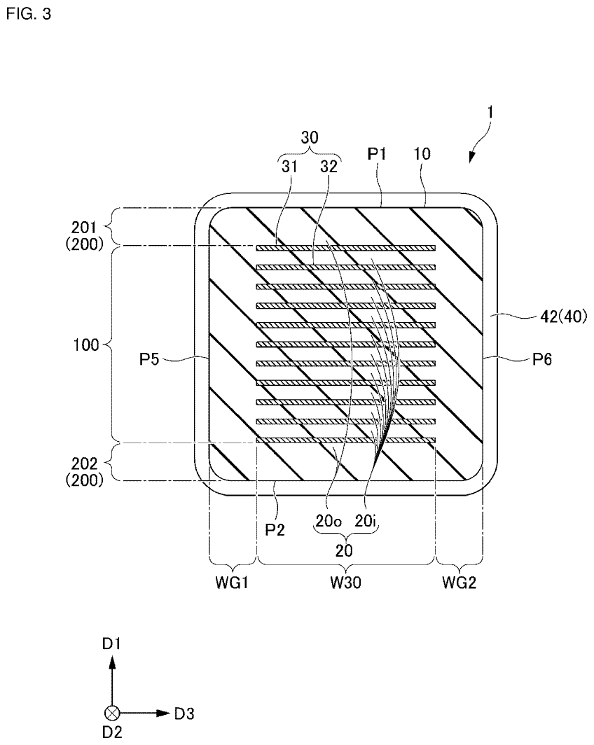

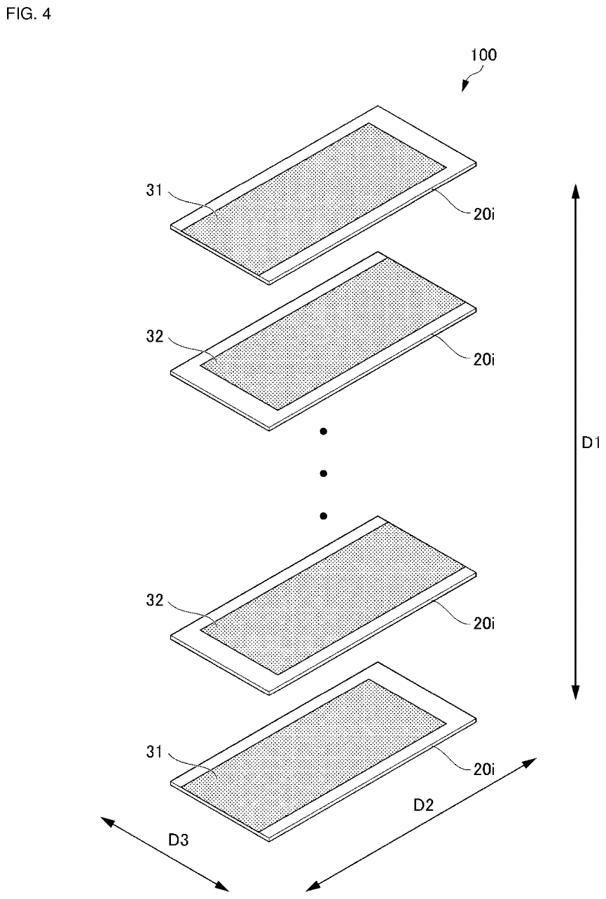

FIG. 1 is a perspective view of a multilayer ceramic capacitor (first example embodiment), FIG. 2 is a cross-sectional view of the multilayer ceramic capacitor taken along line II-II illustrated in FIG. 1, and FIG. 3 is a cross-sectional view of the multilayer ceramic capacitor taken along line III-III illustrated in FIG. 1. FIG. 4 is a schematic diagram of a structure of inner layer portions in the multilayer ceramic capacitor illustrated in FIG. 1. A multilayer ceramic capacitor 1 illustrated in FIG. 1 to FIG. 4 includes a multilayer body 10 and outer electrodes 40. The outer electrodes 40 include a first outer electrode 41 and a second outer electrode 42.

FIG. 1 to FIG. 3 illustrate an orthogonal coordinate system. first direction D1 is a direction in which inner dielectric layers and inner electrode layers, which are describe later, are laminated. A second direction D2 perpendicular to the first direction D1 corresponds to a length direction of the multilayer ceramic capacitor 1 and the multilayer body 10, and a third direction D3 perpendicular to the first direction D1 and the second direction corresponds to a width direction of the multilayer ceramic capacitor 1 and the multilayer body 10. The cross section illustrated in FIG. 2 may also be referred to as a D12 cross section, and the cross section illustrated in FIG. 3 may also be referred to as a D13 cross section.

The first direction D1, the second direction D2, and the third direction D3 may intersect with one another and are not required to be mutually perpendicular.

The multilayer body 10 has a substantially rectangular prism shape, and includes a first surface P1 and a second surface P2 opposite each other in the first direction D1, a third surface P3 and a fourth surface P4 opposite each other in the second direction D2, and a fifth surface P5 and a sixth surface P6 opposite each other in the third direction D3. Each surface may have unevenness or may be roughened.

Preferably, corner portions and ridgelines of the multilayer body 10 may be rounded. At each of the corner portions, three surfaces of the multilayer body 10 intersect, and at each of the ridgelines, two surfaces of the multilayer body 10 intersect.

As illustrated in FIG. 2 and FIG. 3, the multilayer body 10 includes multiple inner dielectric layers 20i and multiple inner electrode layers 30 laminated in the first direction D1. The multilayer body 10 includes, in the first direction D1, an inner layer portion 100, and a first outer layer portion 201 and a second outer layer portion 202 disposed to hold the inner layer portion 100 therebetween.

The inner dielectric layers 20i of the inner layer portion 100 and outer dielectric layers 20o of the outer layer portions 200 may have different component compositions because the inner layer portion 100 and the outer layer portions 200 are to have different functions. For example, the inner dielectric layers 20i are to have a high dielectric constant, whereas the outer dielectric layers 20o are to have high waterproofness, weatherability, and strength.

Thus, the dielectric layers of the inner layer portion 100 are referred to as the inner dielectric layers 20i, and the dielectric layers of the outer layer portions 200 are referred to as the outer dielectric layers 20o. However, when the inner dielectric layers 20i and the outer dielectric layers 20o do not need to be particularly distinguished from each other, they are collectively referred to as dielectric layers 20.

The inner layer portion 100 includes the multiple inner dielectric layers 20i and the multiple inner electrode layers 30. In the inner layer portion 100, the multiple inner electrode layers 30 are disposed to face one another with each of the inner dielectric layers 20i interposed therebetween. The inner layer portion 100 generates capacitance, and substantially functions as a capacitor.

As a material of the dielectric layers 20, for example, a dielectric ceramic including, for example, BaTiO₃, CaTiO₃, SrTiO₃, or CaZrO₃ as a main component may be used. Alternatively, as a material of the dielectric layers 20, for example, a Mn compound, a Fe compound, a Cr compound, a Co compound, or a Ni compound may be added as a secondary component.

Although the thickness of the inner dielectric layers 20i is not particularly limited, for example, the thickness is preferably greater than or equal to about 0.2 μm and less than or equal to about 2.0 μm, and more preferably greater than or equal to about 0.2 μm and less than or equal to about 0.5 μm, for example. When the inner dielectric layers 20i have such a thickness, the inner dielectric layers 20i can improve capacitance while retaining insulating properties.

The first outer layer portion 201 is disposed closer to the first surface P1 of the multilayer body 10, and the second outer layer portion 202 is disposed closer to the second surface P2 of the multilayer body 10. More specifically, the first outer layer portion 201 is disposed between the first surface P1 and one of the multiple inner electrode layers 30 located closest to the first surface P1, and the second outer layer portion 202 is disposed between the second surface P2 and one of the multiple inner electrode layers 30 located closest to the second surface P2. The first outer layer portion 201 and the second outer layer portion 202 do not include the inner electrode layers 30.

The outer layer portions 200 include an insulating material. The first outer layer portion 201 and the second outer layer portion 202 may each include multiple outer dielectric layers 20o, or a single outer dielectric layers 20o. The outer dielectric layers 20o are formed from the same piezoelectric material as the inner dielectric layers 20i, but may include a different component from the inner dielectric layers 20i depending on the intended function.

The outer layer portions 200 preferably include Mn. When a Mn compound is added to the outer dielectric layers 20o of the outer layer portions 200, the particle growth of the dielectric ceramic can be adjusted to finely form the outer layer portions 200. Thus, the multilayer ceramic capacitor 1 can improve waterproofness.

The Mn content is preferably greater than or equal to about 0.5 mol % and less than or equal to about 0.7 mol % with respect to 100 mol of Ti, for example, when the main component of the outer layer portions 200 is, for example, BaTiO₃, CaTiO₃, or SrTiO₃.

Here, the content of a rare earth element is defined with respect to 100 mol of Ti based on the premise that a dielectric ceramic material included in the outer layer portions 200 includes a compound having a perovskite structure (a structure with a formula ABO₃, where B═Ti) as a main component.

The Mn content can be observed through TEM-EDX.

The multiple inner electrode layers 30 include multiple first inner electrode layers 31 and multiple second inner electrode layers 32. The multiple first inner electrode layers 31 and the multiple second inner electrode layers 32 are alternately disposed in the first direction D1 of the multilayer body 10.

The first inner electrode layers 31 each include a first opposing electrode portion 311 and a first drawn electrode portion 312, and the second inner electrode layers 32 each include a second opposing electrode portion 321 and a second drawn electrode portion 322.

The first opposing electrode portion 311 and the second opposing electrode portion 321 face each other with each of the inner dielectric layers 20i interposed therebetween in the first direction D1 of the multilayer body 10. The first opposing electrode portion 311 and the second opposing electrode portion 321 may have any shape, for example, a substantially rectangular shape. The first opposing electrode portion 311 and the second opposing electrode portion 321 generate capacitance and substantially function as capacitors.

The first drawn electrode portion 312 extends from the first opposing electrode portion 311 to the third surface P3 of the multilayer body 10, and is exposed on the third surface P3. The second drawn electrode portion 322 extends from the second opposing electrode portion 321 to the fourth surface P4 of the multilayer body 10, and is exposed on the fourth surface P4. The dimensions of the first opposing electrode portion 311 and the first drawn electrode portion 312 in the third direction D3 may be the same or different. The dimensions of these portions in the third direction D3 may be gradually changed toward the third surface P3 from which they are exposed. The dimensions of the second opposing electrode portion 321 and the second drawn electrode portion 322 in the third direction D3 may be the same or different. The dimensions of these portions in the third direction D3 may be gradually changed toward the fourth surface P4 from which they are exposed.

Thus, the first inner electrode layers 31 are connected to the first outer electrode 41, and a gap is disposed between the first inner electrode layers 31 and the fourth surface P4 of the multilayer body 10, in other words, the second outer electrode 42. In addition, the second inner electrode layers 32 are connected to the second outer electrode 42, and a gap is disposed between the second inner electrode layers 32 and the third surface P3 of the multilayer body 10, in other words, the first outer electrode 41.

The first inner electrode layers 31 and the second inner electrode layers 32 include Ni as a main component. The first inner electrode layers 31 and the second inner electrode layers 32 may include, for example, at least one of a metal such as Cu, Ag, Pd, Sn, or Au, or an alloy such as an Ag—Pd alloy including at least one of these metals, or may include another component. The first inner electrode layers 31 and the second inner electrode layers 32 may further include dielectric particles with the same composition system as a ceramic included in the inner dielectric layers 20i as a component other than the main component. Herein, metal serving as a main component refers to a metal component with the highest weight percent. When the first inner electrode layers 31 and the second inner electrode layers 32 include Sn, electric field concentration on the interface can be reduced, and high thermal load reliability can be improved. Here, regardless of when Sn is included in only the inner electrode layers 30 of either one of the first inner electrode layers 31 and the second inner electrode layers 32, the effects can be fully achieved.

Although the thickness of the first inner electrode layers 31 and the second inner electrode layers 32 is not particularly limited, preferably, the thickness of the first inner electrode layers 31 and the second inner electrode layers 32 is, for example, greater than or equal to about 0.2 μm and less than or equal to about 2.0 μm, and more preferably, greater than or equal to about 0.2 μm and less than or equal to about 0.5 μm, for example. This structure can reduce the thickness while retaining capacitance. The quantities of the first inner electrode layers 31 and the second inner electrode layers 32 are not particularly limited.

The thickness of the inner dielectric layers 20i and the inner electrode layers 30 may be measured by, for example, observing the D12 cross section near the center, in the third direction D3, of the multilayer body exposed by polishing using a scanning electron microscope. Each value may be a mean value of values measured at multiple positions in the second direction D2, or a mean value of values measured at multiple positions in the first direction D1.

As illustrated in FIG. 3, the multilayer body 10 includes, in the third direction D3, an electrode opposing portion W30 in which the inner electrode layers 30 oppose one another, and a first side gap portion WG1 and a second side gap portion WG2 disposed to hold the electrode opposing portion W30 therebetween. The first side gap portion WG1 is located between the electrode opposing portion W30 and the fifth surface P5, and the second side gap portion WG2 is located between the electrode opposing portion W30 and the sixth surface P6. More specifically, the first side gap portion WG1 is located between the fifth surface P5 and the edges of the inner electrode layers 30 closer to the fifth surface P5, and the second side gap portion WG2 is located between the sixth surface P6 and the edges of the inner electrode layers 30 closer to the sixth surface P6. The first side gap portion WG1 and the second side gap portion WG2 simply include the dielectric layers 20 without including the inner electrode layers 30. The first side gap portion WG1 and the second side gap portion WG2 are also referred to as W gaps.

The first side gap portion WG1 and the second side gap portion WG2 may have Si segregation. This segregation may improve bending strength of a multilayer ceramic capacitor.

As illustrated in FIG. 2, the multilayer body 10 includes, in the second direction D2, an electrode opposing portion L30 in which the first inner electrode layers 31 and the second inner electrode layers 32 in the inner electrode layers 30 face one another, a first end gap portion LG1, and a second end gap portion LG2. The first end gap portion LG1 is located between the electrode opposing portion L30 and the third surface P3, and the second end gap portion LG2 is located between the electrode opposing portion L30 and the fourth surface P4. More specifically, the first end gap portion LG1 is located between the third surface P3 and the edges of the second inner electrode layers 32 closer to the third surface P3, and the second end gap portion LG2 is located between the fourth surface P4 and the edges of the first inner electrode layers 31 closer to the fourth surface P4. The first end gap portion LG1 includes the first inner electrode layers 31 and the inner dielectric layers 20i without including the second inner electrode layers 32, and the second end gap portion LG2 includes the second inner electrode layers 32 and the inner dielectric layers 20i without including the first inner electrode layers 31. The first end gap portion LG1 is a portion functioning as a drawn electrode portion to which the first inner electrode layers 31 are drawn to the third surface P3, and the second end gap portion LG2 is a portion functioning as a drawn electrode portion to which the second inner electrode layers 32 are drawn to the fourth surface P4. The first end gap portion LG1 and the second end gap portion LG2 are also referred to as L gaps.

In the electrode opposing portion L30, the first opposing electrode portions 311 of the first inner electrode layers 31 and the second opposing electrode portions 321 of the second inner electrode layers 32 are located. In the first end gap portion LG1, the first drawn electrode portions 312 of the first inner electrode layers 31 are located, and in the second end gap portion LG2, the second drawn electrode portions 322 of the second inner electrode layers 32 are located.

For example, the dimension of the multilayer body 10 in the first direction D1 may be measured by observing, using a scanning electron microscope, the D12 cross section near the center of the multilayer body in the third direction D3 exposed by polishing, or the D13 cross section near the center of the multilayer body in the second direction D2 exposed by polishing. Each value may be a mean value of values measured at multiple positions in the second direction D2 or the third direction D3.

Similarly, for example, the dimension of the multilayer body 10 in the second direction may be measured by observing, using a scanning electron microscope, the D12 cross section near the center of the multilayer body in the third direction D3 exposed by polishing. Each value may be a mean value of values measured at multiple positions in the first direction D1.

Similarly, for example, the dimension of the multilayer body 10 in the third direction may be measured by observing, using a scanning electron microscope, the D13 cross section near the center of the multilayer body in the second direction D2 exposed by polishing. Each value may be a mean value of values measured at multiple positions in the first direction D1.

Preferably, the dimension of the multilayer body in the first direction D1 is greater than or equal to about 0.1 mm and less than or equal to about 1.0 mm, the dimension of the multilayer body in the second direction D2 is greater than or equal to about 0.2 mm and less than or equal to about 1.8 mm, and the dimension of the multilayer body in the third direction D3 is greater than or equal to about 0.1 mm and less than or equal to about 1.0 mm, for example.

The outer electrodes 40 include the first outer electrode 41 and the second outer electrode 42.

The first outer electrode 41 is disposed on the third surface of the multilayer body 10, and connected to the first inner electrode layers 31. The first outer electrode 41 may extend from the third surface P3 to a portion of the first surface P1 and a portion of the second surface P2. The first outer electrode 41 may extend from the third surface P3 to a portion of the fifth surface P5 and a portion of the sixth surface P6.

The second outer electrode 42 is disposed on the fourth surface P4 of the multilayer body 10, and connected to the second inner electrode layers 32. The second outer electrode 42 may extend from the fourth surface P4 to a portion of the first surface P1 and a portion of the second surface P2. The second outer electrode 42 may extend from the fourth surface P4 to a portion of the fifth surface P5 and a portion of the sixth surface P6.

The first outer electrode 41 includes a first base electrode layer 415 and a first plating layer 416, and the second outer electrode 42 includes a second base electrode layer 425 and a second plating layer 426. The first outer electrode 41 may simply include the first plating layer 416, and the second outer electrode 42 may simply include the second plating layer 426.

The first base electrode layer 415 and the second base electrode layer 425 may each be a fired layer including metal and glass. Examples of the glass component include at least one of, for example, B, Si, Ba, Mg, Al, or Li. For example, borosilicate glass may be used. For example, Cu is included as a main component of metal. For example, at least one of a metal such as Ni, Ag, Pd, or Au or an alloy such as an Ag—Pd alloy may be included as a main component of metal, or as a component other than the main component.

The fired layer is a layer formed by applying electroconductive paste including metal and glass to the multilayer body by a dip method and firing the applied paste. The paste may be fired after firing the inner electrode layers or concurrently with the firing of the inner electrode layers. One or more fired layers may be formed.

Alternatively, the first base electrode layer 415 and the second base electrode layer 425 may be resin layers including electroconductive particles and thermosetting resin. The resin layers may be formed on the above fired layer, or may be directly formed on the multilayer body without forming the fired layer.

The resin layers are formed by applying electroconductive paste including electroconductive particles and thermosetting resin to the multilayer body by an application method and firing the applied paste. The paste may be fired after firing the inner electrode layers or concurrently with the firing of the inner electrode layers. One or more resin layers may be formed.

Each of the first base electrode layer 415 and the second base electrode layer 425 formed from one or more fired layers or one or more resin layers may have any thickness, and may be greater than or equal to about 1 μm and less than or equal to about 10 μm, for example.

Alternatively, the first base electrode layer 415 and the second base electrode layer 425 may be formed by a thin-film forming method such as sputtering or vapor deposition, and may each be a thin film layer with a thickness less than or equal to about 1 μm and formed by deposition of metal particles, for example.

The first plating layer 416 covers at least a portion of the first base electrode layer 415, and the second plating layer 426 covers at least a portion of the second base electrode layer 425. For example, the first plating layer 416 and the second plating layer 426 include at least one of a metal such as Cu, Ni, Ag, Pd, or Au or an alloy such as an Ag—Pd alloy.

The first plating layer 416 and the second plating layer 426 may each include multiple layers. Preferably, the first plating layer 416 and the second plating layer 426 may have a two-layer structure including Ni plating and Sn plating. An Ni plating layer can prevent the base electrode layer from being eroded by solder when the ceramic electronic component is being mounted. The Sn plating layer improves solder wettability when the ceramic electronic component is being mounted, and facilitates mounting. The first plating layer 416 and the second plating layer 426 may have a three-layer structure formed by laminating Sn plating, Ni plating, and Sn plating. The outermost layer may be Au plating.

The first plating layer 416 and the second plating layer 426 may each have any thickness, and may be greater than or equal to about 1 μm and less than or equal to about 10 μm, for example.

The multiple inner electrode layers 30 included in the inner layer portion 100 include Ni as a main component, and an Mn—Ni oxide area A is provided in at least a portion of any of the multiple inner electrode layers 30. More specifically, an Mn—Ni oxide area A may be provided in at least a portion of each of the multiple inner electrode layers 30 included in the inner layer portion 100, or in at least a portion of at least one of the multiple inner electrode layers 30 included in the inner layer portion 100. When an Mn—Ni oxide area A is formed in at least a portion of any of the multiple inner electrode layers 30, the inner electrode layers 30 can improve waterproofness.

A multilayer ceramic capacitor is polished until it has a half dimension in the third direction D3, to expose a cross section (D12 cross section) parallel to the first direction D1 and the second direction D2. Identification can be performed by TEM-EDX measurement using JEM-2200FS or JEM-F200 from JEOL Ltd.

When the inner layer portion 100 is trisected in the first direction D1 into a closer-to-first-surface region R1, a middle region RC, and a closer-to-second-surface region R2 in order from the first surface P1, preferably, the Mn-Ni oxide areas A are included, at a higher ratio, in the inner electrode layers 30 in the closer-to-first-surface region R1 and the closer-to-second-surface region R2 than in the inner electrode layers in the middle region RC. When the Mn—Ni oxide areas A are included, at a higher ratio, in the inner electrode layers 30 in the closer-to-first-surface region R1 and the closer-to-second-surface region R2, water infiltration in the first direction D1 can be reduced, and the multilayer ceramic capacitor 1 can improve waterproofness. To increase the ratio of the Mn—Ni oxide areas A in the inner electrode layers 30 in the closer-to-first-surface region R1 or the closer-to-second-surface region R2, the outer dielectric layers 20o preferably include Mn.

In the inner layer portion 100, preferably, the region ratio of the Mn—Ni oxide areas with respect to the entire areas of the inner electrode layers 30 located within about 20 μm in the first direction D1 from one of the multiple inner electrode layers 30 closest to the first surface P1, or the inner electrode layers 30 located within about 20 μm in the first direction from one of the multiple inner electrode layers 30 closest to the second surface P2 is greater than or equal to about 170 ppm and less than or equal to about 300 ppm, for example.

When the region ratio of the Mn—Ni oxide areas is smaller than about 170 ppm, the outer layer portion has insufficient densification. When the region ratio of the Mn—Ni oxide areas is greater than about 300 ppm, the region ratio of the Mn—Ni oxide areas is excessive, and a structural defect may occur.

Thus, to reduce water infiltration from the outside and to improve waterproofness, the region ratio of the Mn—Ni oxide areas is preferably greater than or equal to about 170 ppm and less than or equal to about 300 ppm, for example.

Preferably, the outer dielectric layers 20o include Mn to adjust the region ratio of the Mn—Ni oxide areas in the inner electrode layers 30 located within about 20 μm in the first direction D1 from one of the multiple inner electrode layers 30 closest to the first surface P1, or the inner electrode layers 30 located within about 20 μm in the first direction from one of the multiple inner electrode layers 30 closest to the second surface P2, for example.

A multilayer ceramic capacitor is polished until it has a half dimension in the third direction D3, to expose a cross section (D12 cross section) parallel to the first direction D1 and the second direction D2. The Mn—Ni oxide region ratio was measured by measuring the length of the Mn—Ni oxide areas with respect to each inner electrode in each area using VHX-8000 from KEYENCE CORPORATION, at a magnification of 150 under bright-field conditions.

Preferably, a solid-solution Dy content around the Mn—Ni oxide areas A is higher in the inner dielectric layers 20i in the closer-to-first-surface region R1 or the closer-to-second-surface region R2 than in the inner dielectric layers 20i in the middle region RC.

In this structure, the dimension of the inner dielectric layers in the first direction D1 is smaller, and the solid-solution Dy content is higher in the area near the outer layer portions susceptible to insulation deterioration. Thus, insulation reliability can be improved.

An example of a method for manufacturing the multilayer ceramic capacitor 1 is described now.

Dielectric sheets for the dielectric layers 20 and electroconductive paste for the inner electrode layers 30 are prepared. The dielectric sheets and the electroconductive paste include a binder and solvent. Known materials may be used as the binder and the solvent.

Preferably, for example, BaTiO₃, CaTiO₃, or SrTiO₃ is used as a main component of the dielectric sheets for the inner dielectric layers 20i, and the Dy content is greater than or equal to about 0.97 mol % and less than or equal to about 1.07 mol % with respect to 100 mol of Ti, for example.

Here, the content of a rare earth element defined with respect to 100 mol of Ti based on the premise that a dielectric ceramic material forming the inner dielectric layers 20i includes a compound having a perovskite structure (a structure with a formula ABO₃, where B═Ti) as a main component.

The Dy content can be observed through TEM-EDX.

Preferably, for example, BaTiO₃, CaTiO₃, or SrTiO₃ is used as a main component of the dielectric sheets for the outer dielectric layers 20o, and the Mn content is greater than or equal to about 0.5 mol % and less than or equal to about 0.7 mol % with respect to 100 mol of Ti, for example.

Here, the content of a rare earth element is defined with respect to 100 mol of Ti based on the premise that a dielectric ceramic material forming the inner dielectric layers 20i includes a compound having a perovskite structure (a structure with a formula ABO₃, where B═Ti) as a main component.

The Mn content can be observed through TEM-EDX.

Thereafter, for example, a predetermined pattern is printed on a dielectric sheet with the electroconductive paste to form an inner electrode pattern on the dielectric sheet. The inner electrode pattern may be formed by, for example, screen printing or gravure printing.

Thereafter, a predetermined number of dielectric sheets for the second outer layer portion 202 on which no internal electrode pattern is printed are laminated. On the dielectric sheets thus laminated, a dielectric sheet for the inner layer portion 100 on which an inner electrode pattern is printed is sequentially laminated. On the dielectric sheet thus laminated, a predetermined number of dielectric sheets for the first outer layer portion 201 on which no internal electrode pattern is printed are laminated. Thus, a multilayer sheet is fabricated.

The multilayer sheet thus obtained is then pressed in the first direction D1 by a method such as isostatic pressing to fabricate a multilayer block. The multilayer block is then cut into a predetermined size to form multilayer chips. At this time, the corner portions and the ridgelines of each multilayer chip are rounded by, for example, barrel polishing.

Each multilayer chip may be cut to have the inner electrode patterns exposed on both surfaces in the third direction D3, and cover dielectric sheets serving as the first side gap portion WG1 and the second side gap portion WG2 may be bonded to cover both surfaces.

Each multilayer chip is then fired to fabricate the multilayer body 10. Although depending on the material of the dielectric substance or the internal electrode, the firing temperature is preferably greater than or equal to about 900° C. and less than or equal to about 1400° C., for example.

When a multilayer body is fired to have the ratio of the Mn—Ni oxide areas located within about 20 μm inward in the first direction D1 from the inner electrode closest to the outer layer portion of about 170 ppm to about 300 ppm, for example, the outer layer portions are densified, and waterproofness can be improved. Thereafter, reoxidation treatment is performed, and the solid-solution Dy content around the Mn—Ni oxide areas is controlled. Thus, insulation deterioration can be reduced.

Thereafter, with a dip method, the third surface P3 of the multilayer body 10 is immersed in electroconductive paste serving as an electrode material for the base electrode layer to apply electroconductive paste for the first base electrode layer 415 to the third surface P3. Similarly, with a dip method, the fourth surface P4 of the multilayer body 10 is immersed in electroconductive paste serving as an electrode material for the base electrode layer to apply electroconductive paste for the second base electrode layer 425 to the fourth surface P4. Thereafter, the electroconductive paste is fired to form the first base electrode layer 415 and the second base electrode layer 425 serving as fired layers. The firing temperature is preferably greater than or equal to about 600° C. and less than or equal to about 900° C., for example.

As described above, the first base electrode layer 415 and the second base electrode layer 425 may be formed into resin layers by applying electroconductive paste including electroconductive particles and thermosetting resin by an application method and firing the applied paste, or the first base electrode layer 415 and the second base electrode layer 425 may be formed into thin films by a thin-film forming method such as sputtering or vapor deposition.

Thereafter, the first plating layer 416 is formed on the surface of the first base electrode layer 415 to form the first outer electrode 41, and the second plating layer 426 is formed on the surface of the second base electrode layer 425 to form the second outer electrode 42. With the above processes, the multilayer ceramic capacitor 1 is obtained.

Example embodiments of the present invention are not limited to the multilayer ceramic capacitor 1 with limited characteristics such as a shape, but is widely applicable to any multilayer ceramic capacitor including the inner layer portion 100 formed by laminating the inner dielectric layers 20i and the inner electrode layers 30.

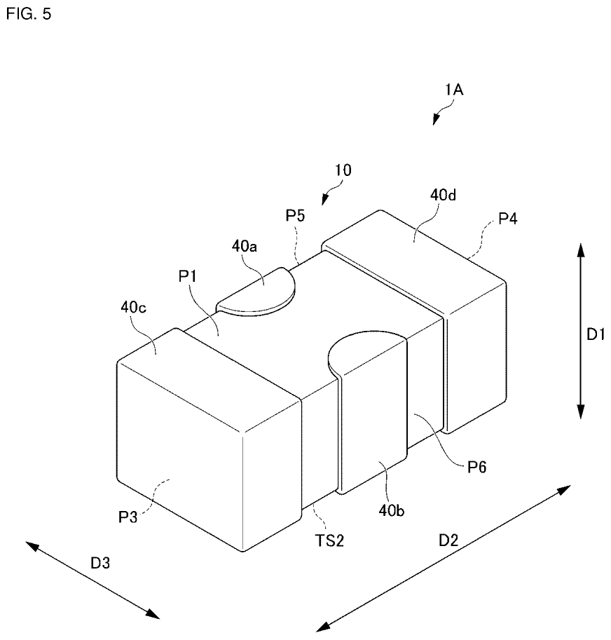

For example, as illustrated in FIG. 5, a multilayer ceramic capacitor 1A includes an outer electrode 40a and an outer electrode 40b respectively disposed on the fifth surface P5 and the sixth surface P6 of the multilayer body 10, and an outer electrode 40c and an outer electrode 40d respectively disposed on the third surface P3 and the fourth surface P4 of the multilayer body 10.

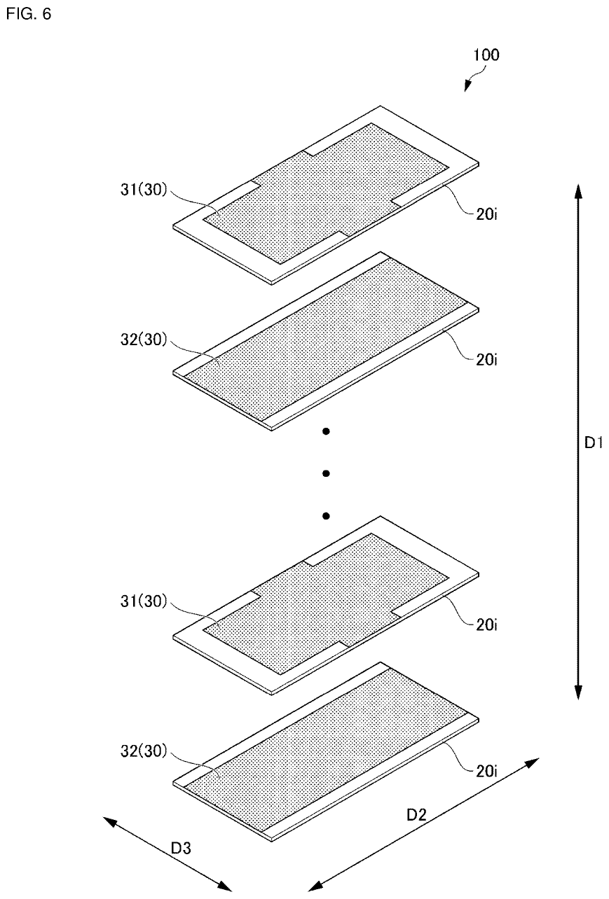

As illustrated in FIG. 6, the inner layer portion 100 includes the multiple inner dielectric layers 20i and the multiple inner electrode layers 30. The inner layer portion 100 includes the inner electrode layers 30 from the inner electrode layer 30 located closest to the first surface P1 to the inner electrode layer 30 located closest to the second surface P2 in the first direction D1. In the inner layer portion 100, the multiple inner electrode layers 30 are disposed to face one another, with each of the inner dielectric layers 20i interposed therebetween.

The multiple inner electrode layers 30 include the multiple first inner electrode layers 31 and the multiple second inner electrode layers 32. The multiple first inner electrode layers 31 are disposed on the multiple inner dielectric layers 20i. The multiple second inner electrode layers 32 are disposed on the multiple inner dielectric layers 20i. The multiple first inner electrode layers 31 and the multiple second inner electrode layers 32 are alternately disposed in the first direction D1 of the multilayer body 10 with each of the inner dielectric layers 20i interposed therebetween. The first inner electrode layers 31 and the second inner electrode layers 32 are disposed while holding the inner dielectric layers 20i therebetween.

The first inner electrode layers 31 are connected to the outer electrodes 40a and 40b on the fifth surface P5 and the sixth surface P6 of the multilayer body 10, and the second inner electrode layers 32 are connected to the outer electrodes 40c and 40d on the third surface P3 and the fourth surface P4 of the multilayer body 10.

The multilayer ceramic capacitor 1A disconnects a power line or a signal line in a circuit in the middle, connects the outer electrode 40c to one end of the disconnected line, connects the outer electrode 40d to the other end of the disconnected line, and connects the outer electrodes 40a and 40b to the ground, to be usable as a three-terminal capacitor. In this case, the second inner electrode layers 32 serve as through electrodes, and the first inner electrode layers 31 serve as ground electrodes.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor, comprising:
a multilayer body that includes:
an inner layer portion including a plurality of inner dielectric layers and a plurality of inner electrode layers laminated in a first direction; and
a pair of outer layer portions including outer dielectric layers holding the inner layer portion therebetween in the first direction;
the multilayer body including a first surface and a second surface opposite each other in the first direction, a third surface and a fourth surface opposite each other in a second direction perpendicular to the first direction, and a fifth surface and a sixth surface opposite each other in a third direction perpendicular to the first direction and the second direction; and
a pair of outer electrodes located at two end portions of the multilayer body in the second direction or in the third direction, and connected to the inner electrode layers; wherein
the plurality of inner electrode layers include Ni as a main component, and an Mn—Ni oxide area is included in at least a portion of any of the plurality of inner electrode layers.

2. The multilayer ceramic capacitor according to claim 1, wherein
the outer dielectric layers include Mn; and
when the inner layer portion is trisected in the first direction into a closer-to-first-surface region, a middle region, and a closer-to-second-surface region in order from the first surface, the Mn—Ni oxide area is included, at a higher ratio, in the inner electrode layers in the closer-to-first-surface region and the closer-to-second-surface region than in the inner electrode layers in the middle region.

3. The multilayer ceramic capacitor according to claim 1, wherein
the outer dielectric layers include Mn; and
in the inner layer portion, a region ratio of the Mn—Ni oxide area with respect to entire areas of the inner electrode layers located within about 20 μm in the first direction from one of the plurality of inner electrode layers closest to the first surface, or of the inner electrode layers located within about 20 μm in the first direction from one of the plurality of inner electrode layers closest to the second surface is greater than or equal to about 170 ppm and less than or equal to about 300 ppm.

4. The multilayer ceramic capacitor according to claim 2, wherein a solid-solution Dy content around the Mn—Ni oxide area is higher in the inner dielectric layers in the closer-to-first-surface region or the closer-to-second-surface region than in the inner dielectric layers in the middle region.

5. The multilayer ceramic capacitor according to claim 1, wherein the multilayer body includes rounded corner portions and rounded ridgelines.

6. The multilayer ceramic capacitor according to claim 1, wherein the plurality of inner electrodes include at least one of Cu, Ag, Pd, Sn, or Au, or an alloy including at least one of Cu, Ag, Pd, Sn, or Au.

7. The multilayer ceramic capacitor according to claim 1, wherein the plurality of inner electrodes include dielectric particles with a same composition system as a ceramic included in the plurality of inner dielectric layers.

8. The multilayer ceramic capacitor according to claim 1, wherein the plurality of inner electrodes include Sn.

9. The multilayer ceramic capacitor according to claim 1, wherein each of the plurality of inner electrodes has a thickness of greater than or equal to about 0.2 μm and less than or equal to about 2.0 μm, and more preferably, greater than or equal to about 0.2 μm and less than or equal to about 0.5 μm.

10. The multilayer ceramic capacitor according to claim 1, wherein each of the pair of outer electrodes includes a base electrode layer and a plating layer.

11. A multilayer ceramic capacitor, comprising:
a multilayer body that includes:
an inner layer portion including a plurality of inner dielectric layers and a plurality of inner electrode layers laminated in a first direction; and
a pair of outer layer portions including outer dielectric layers holding the inner layer portion therebetween in the first direction;
the multilayer body including a first surface and a second surface opposite each other in the first direction, a third surface and a fourth surface opposite each other in a second direction perpendicular to the first direction, and a fifth surface and a sixth surface opposite each other in a third direction perpendicular to the first direction and the second direction; and
outer electrodes located at two end portions of the multilayer body in the second direction and at two end portions of the multilayer body in the third direction, and connected to the inner electrode layers; wherein
the plurality of inner electrode layers include Ni as a main component, and an Mn—Ni oxide area is included in at least a portion of any of the plurality of inner electrode layers.

12. The multilayer ceramic capacitor according to claim 11, wherein
the outer dielectric layers include Mn; and
when the inner layer portion is trisected in the first direction into a closer-to-first-surface region, a middle region, and a closer-to-second-surface region in order from the first surface, the Mn—Ni oxide area is included, at a higher ratio, in the inner electrode layers in the closer-to-first-surface region and the closer-to-second-surface region than in the inner electrode layers in the middle region.

13. The multilayer ceramic capacitor according to claim 11, wherein
the outer dielectric layers include Mn; and
in the inner layer portion, a region ratio of the Mn—Ni oxide area with respect to areas of the inner electrode layers located within about 20 μm in the first direction from one of the inner electrode layers closest to the first surface, and of the inner electrode layers located within about 20 μm in the first direction from one of the inner electrode layers closest to the second surface is greater than or equal to about 170 ppm and less than or equal to about 300 ppm.

14. The multilayer ceramic capacitor according to claim 12, wherein
the inner dielectric layers include Dy; and
a solid-solution Dy content is higher in the inner dielectric layers around the Mn—Ni oxide area in the closer-to-first-surface region and the closer-to-second-surface region than in the inner dielectric layers around the Mn—Ni oxide area in the middle region.

15. The multilayer ceramic capacitor according to claim 12, wherein the multilayer body includes rounded corner portions and rounded ridgelines.

16. The multilayer ceramic capacitor according to claim 12, wherein the plurality of inner electrodes include at least one of Cu, Ag, Pd, Sn, or Au, or an alloy including at least one of Cu, Ag, Pd, Sn, or Au.

17. The multilayer ceramic capacitor according to claim 12, wherein the plurality of inner electrodes include dielectric particles with a same composition system as a ceramic included in the plurality of inner dielectric layers.

18. The multilayer ceramic capacitor according to claim 12, wherein the plurality of inner electrodes include Sn.

19. The multilayer ceramic capacitor according to claim 12, wherein each of the plurality of inner electrodes has a thickness of greater than or equal to about 0.2 μm and less than or equal to about 2.0 μm, and more preferably, greater than or equal to about 0.2 μm and less than or equal to about 0.5 μm.

20. The multilayer ceramic capacitor according to claim 12, wherein each of the pair of outer electrodes includes a base electrode layer and a plating layer.
